(19) United States
(12) Patent Application Publication
(10) Pub. No.: US 2008/0022979 A1
(43) Pub. Date: Jan. 31, 2008

(54) METHOD AND SYSTEM FOR EFFICIENTLY VAPORIZING GASOLINE

(76) Inventor: Edward F. Ward, Wilmington, MA (US)

Correspondence Address: BARLOW, JOSEPHS & HOLMES, LTD., 101 DYER STREET, 5TH FLOOR, PROVIDENCE, RI, 02903, US

(21) Appl. No.: 11/738,792

(22) Filed: Apr. 23, 2007

Related U.S. Application Data
(60) Provisional application No. 60/747,242, filed on May 15, 2006.

(51) Int. Cl. F02M 17/22

(52) U.S. Cl. 123/522

(57) ABSTRACT

A method and system is disclosed for vaporization of a liquid fuel in a manner that produces a highly concentrated air-fuel mixture using a combination of gasoline and air while eliminating residual liquid fuel droplets therefrom. The system generally includes at least two tanks including a manifold adjacent the bottom thereof. An outlet on the first tank is connected to an inlet connected in the manifold of the second tank. The tanks contain liquid fuel. Compressed air is introduced into the manifold in the first tank causing some of the liquid gasoline to vaporize. The vaporized gasoline is then introduced to the manifold in the second tank causing additional vaporization. The saturated vapor is then drawn off the top of the second tank in the form of a combustible gas vapor for use in any application wherein such an air-fuel mixture is normally utilized.

### CROSS-REFERENCE TO RELATED APPLICATIONS

This application is related to and claims priority from earlier filed U.S. Provisional Patent Application No. 60/747,242, filed May 15, 2006, the contents of which are incorporated herein by reference.

### BACKGROUND OF THE INVENTION

The present invention relates generally to a method and system for vaporizing liquid fuels, such as gasoline, for use in the combustion process. More specifically, the present invention relates to a system that is configured to produce a highly concentrated vaporized fuel with very little liquid residue therein that results in an improvement in combustion performance and efficiency.

In response to the growing concerns related to both the financial and environmental costs associated with the use of petroleum based fuels, there has been a movement towards improving the efficiency of the various equipment that rely on the burning of such fuels for the release of energy. In addition, there are a growing number of regulations directed towards the reduction of many of the emissions generated by such combustion processes. While there have been a number of different methods and systems created for the express purpose of vaporizing petroleum based fuels to achieve a higher burning efficiency, most of these systems still achieve relatively low efficiency performance in terms of actual BTUs achieved per gallon of fuel consumed.

Much of the difficulty in most of the prior art combustion processes arises from the fact that, in its liquid form, the fuel cannot be easily burned. As a result, the fuel must be atomized or vaporized and dispersed throughout a volume of air before it can be burned. For example, in a conventional internal combustion engine, a carburetor is employed to atomize the fuel. The liquid fuel is aspirated by the flow of air through the throat of the carburetor and small droplets of liquid gasoline are dispersed into the air airflow through a venturi jet. This fuel air mixture is then introduced to the engine combustion chamber where it is burned. While this system has been the standard for many years, the system still has upper limits on the overall efficiency that can be achieved. The problem is that the fuel droplets that are deposited into the airflow are randomly sized and the larger droplets do not completely vaporize and therefore provide some residual liquid fuel that does not burn in the combustion process. This results in incomplete combustion, a loss of fuel economy, and contributes to pollutants in the engine exhaust.

While some improvements have been achieved through the use of fuel injection systems wherein the fuel is introduced to the system via a pressurized nozzle, the problem remains that the fuel being mixed with the air remains in a substantially liquid form. While the droplet size in a fuel injection system is more predictable and controlled, the fuel is still being introduces in droplet form. Similarly, in heating devices such as residential boilers, burners are used that employ an induction fan to scatter the fuel into droplets for combustion. As with internal combustion engines, the same inefficiencies exist in such burners.

Other alternatives in the prior art include devices known as vapor engines wherein the liquid fuel is vaporized by heating it before it is mixed with incoming air. While such vapor engines improve the engine's combustion efficiency, they often result in unstable combustion and a loss of power due to the high temperature of the fuel-air mixture entering the engine combustion chambers. Similarly, other devices rely on drawing combustion intake air through the liquid fuel via the vacuum created by the engine to create an air fuel mixture. These devices, however, are highly passive and due to the limited vacuum available result in a very lean airfuel mixture that produces a reduced power output when burned.

Accordingly, there is a need for a system that can vaporize fuel in a highly efficient manner thereby improving the overall combustibility of the fuel. There is a further need for a system that can produce a highly concentrated vaporized fuel that exhibits highly efficient burning characteristics. There is still a further need for a method and system for vaporizing a liquid fuel to produce a highly concentrated combustible vapor while reducing or eliminating residual liquid fuel droplets from the combustible vapor.

### BRIEF SUMMARY OF THE INVENTION

In this regard, the present invention provides for a fuel vaporization system that produces a highly concentrated air-fuel mixture using a combination of gasoline and air that eliminates the residual liquid fuel droplets typically found in prior art systems. Further, the present invention also overcomes the heating and lean mixture issues that have prevented the widespread use of vapor engines or vacuum induced mixing chambers. The system of the present invention generally includes at least two tanks, wherein each of the tanks include a manifold assembly installed adjacent the bottom thereof. An outlet on the first tank is connected to an inlet connected in the manifold of the second tank. The tanks are filled with enough liquid gasoline to fully cover the entire manifold assembly. Compressed air is introduced into the manifold in the first tank that in turn bubbles through the liquid gasoline causing some of the liquid gasoline to vaporize. The vaporized gasoline is then drawn off the top of the first tank and introduced to the manifold in the second tank to again bubble through the liquid gasoline causing additional vaporization. The saturated vapor is then drawn off the top of the second tank in the form of a combustible gas vapor for use in any application wherein such an air-fuel mixture is normally utilized.

The present invention therefore provides a system for efficiently vaporizing and concentrating gasoline vapors in a manner that greatly increases its efficiency and utility in combustion operations. Rather than relying on the principal of scattering the fuel into an airflow, the present invention percolates the airflow directly through the liquid fuel. In this manner, the air can only carry fuel vapor thereby eliminating the possibility of having liquid residue within the air-fuel mixture. Further, the system of the present invention operates through the use of compressed air and as a result, no additional heat is required for the system to operate.

It is therefore an object of the present invention to provide a system that can fully vaporize fuel in a highly efficient manner thereby eliminating liquid fuel residue from the air-fuel mixture thereby improving the overall combustibility of the fuel. There is a further need for a system that can produce a highly concentrated vaporized fuel that exhibits highly efficient burning characteristics. There is still a further need for a method and system for vaporizing a liquid fuel to produce a highly concentrated combustible vapor while reducing or eliminating residual liquid fuel droplets from the combustible vapor.

These together with other objects of the invention, along with various features of novelty, which characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In the drawings which illustrate the best mode presently contemplated for carrying out the present invention:

FIG. 1 is a front perspective view of a first embodiment of the system for vaporizing liquid fuel in accordance with the present invention;

FIG. 2 is a schematic cross-sectional view of the system in FIG. 1 taken along line 2-2;

FIG. 3 is a schematic cross-sectional view of a second embodiment of the system for vaporizing liquid fuel in accordance with the teachings of the present invention; and

FIG. 4 is a schematic cross-sectional view of a third embodiment of the system for vaporizing liquid fuel in accordance with the teachings of the present invention.

### DETAILED DESCRIPTION OF THE INVENTION

Now referring to the drawings, the fuel vaporization system of the present invention is shown and generally illustrated in the figures. As can be seen, the present invention provides for a fuel vaporization system that produces a highly concentrated air-fuel mixture using a combination of a liquid fuel and air that eliminates the residual liquid fuel droplets typically found in prior art systems. Further, the present invention also overcomes the heating and lean mixture issues that have prevented the widespread use of vapor engines of vacuum induced mixing chambers. In the context of the present invention, the term liquid fuel is intended to cover any type of fuel that is vaporized in preparation for combustion including but not limited to gasoline, fuel oil, diesel, ethanol, alcohol, bio-diesel, waste cooking oil, etc.

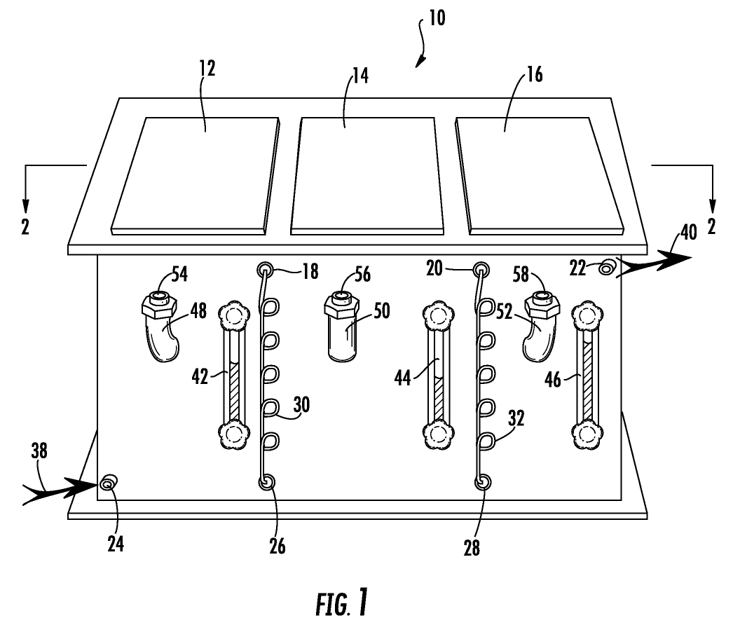

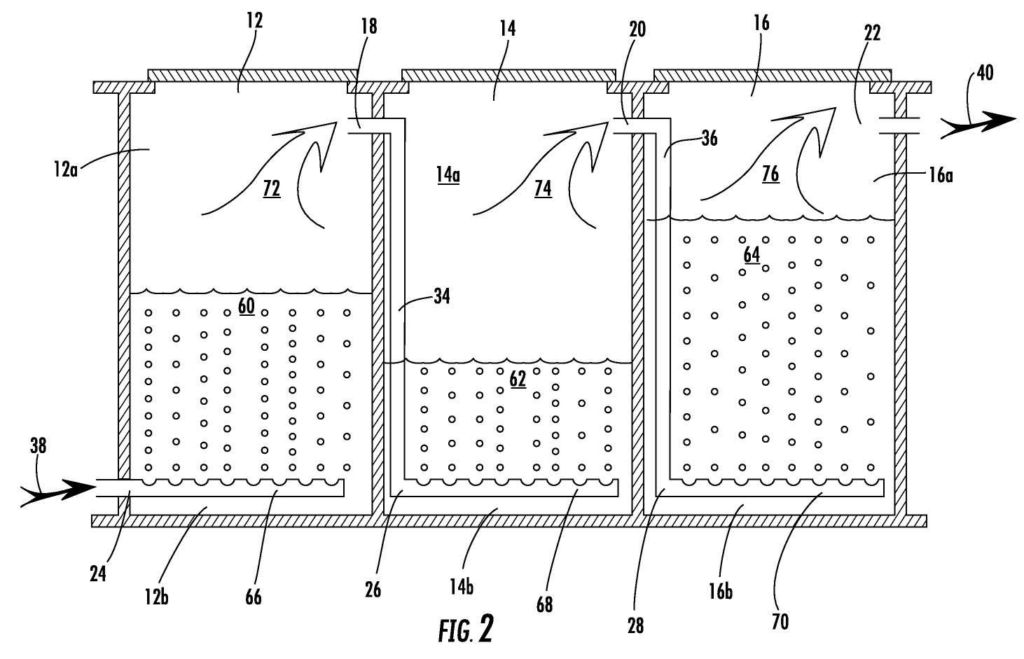

Turning to FIGS. 1 and 2 in combination, the system 10 of the present invention generally includes at least two tanks 12, 14, 16, and in the first preferred embodiment as is depicted in FIGS. 1 and 2 includes three tanks 12, 14, 16. Each of the tanks 12, 14, 16 is an airtight vessel capable of being pressurized and retaining pressure. The tanks 12, 14, 16 have a top portion 12a, 14a, 16a with an outlet port 18, 20, 22 proximate the top of the tank 12, 14, 16 and a bottom portion 12b, 14b, 16b with an inlet 24, 26, 28 proximate a bottom portion of the tank 12, 14, 16. It is preferred that in all embodiments disclosed herein that the tanks 12, 14, 16, regardless of number, are arranged in a series relationship whereby the outlet 18, 20, 22 of the first tank is in fluid communication, via the hose 30, 32 depicted or any other connection such as the hard pipe connection 34, 36 shown in FIG. 2, with the inlet 24, 26, 28 of the second tank and so on for the entire series of tanks. Further, the first tank 12 can be seen to include an input port 24 that provides a location for the introduction of a pressurized airflow 38 and the last tank 16 can be seen to include an outlet port 22 for outputting the vaporized air-fuel mixture 40 as will be described in more detail below. Each of the tanks 12, 14, 16 can also be sent to include means 42, 44, 46 for visually determining the level of liquid fuel within each of said at least two tanks 12, 14, 16. Such means 42, 44, 46 may be any suitable means known in the art including but not limited to a sight glass, a translucent panel, a float indicator, an analog fuel gauge, a digital fuel gauge, etc. Further, the tanks 12, 14, 16 can also be seen to include filler ports 48, 50, 52 therein to allow additional liquid fuel to be added to the interior of the tank 12, 14, 16. Such filler ports 48, 50, 52 must include covers 54, 56, 58 and be capable of maintaining an airtight seal once the liquid fuel has been added to the tanks 12, 14, 16.

As can best be seen in FIG. 2, each of the tanks 12, 14, 16 is at least partially filled with a liquid fuel 60, 62, 64 whereby the level of liquid fuel 60, 62, 64 in each tank 12, 14, 16 is sufficient to cover the inlet ports 24, 26, 28 within the tanks 12, 14, 16. Further, while the inlet ports 24, 26, 28 may simply be an open ended pipe, it is preferred that each of the tanks 12, 14, 16 include a manifold assembly 66, 68, 70 that is installed adjacent the bottom of the tank 12, 14, 16 and is in fluid communication with the tank inlet ports 24, 26, 28. The manifold 66, 68, 70 can be any suitable distribution manifold consisting of an arrangement of interconnected passageways or pipes that include a plurality of holes therein to allow the compressed air 38 introduced to the input port 24, 26, 28 to percolate out of the manifold 66, 68, 70 and through the liquid fuel 60, 62, 64. Further, the manifold 66, 68, 70 may be arranged so that the holes face upwardly or downwardly without changing the method or system of the present invention. In the case where a manifold 66, 68, 70 assembly is employed, the tanks 12, 14, 16 are filled with enough liquid fuel 60, 62, 64 so that the liquid fuel fully covers the entire manifold assembly 66, 68, 70.

In the preferred embodiment, the manifold 42, 44, 46 is a series of interconnected small diameter pipes or tubing having a plurality of small holes in the exterior walls thereof. Further, it is preferable that when the manifold 42, 44, 46 in installed into the tank, the plurality of holes are directed downwardly. The manifold 42 in the first tank 12 has an input 24 that is directed to the exterior of the tank 12 and is configured to interface with a source of compressed air 38. The source of compressed air may be an air compressor, a turbo, an air pump, an air induction device such as the type typically on performance engines or the like. The compressed airflow 38 then enters the manifold 66, 68, 70 and bubbles into the liquid fuel 60, 62, 64 causing it to churn and allowing the vaporized liquid fuel 60, 62, 64 to combine with air.

In operation, the outlet 18 on the first tank 12 is connected to an inlet 26 that is in turn connected in the manifold 68 within the next or the second tank 14. Similarly, the outlet 20 on the second tank 14 is connected to an inlet 28 that is in turn connected in the manifold 70 within the next or the third tank 16. Compressed airflow 38 is introduced into the manifold 66 in the first tank 12 that in turn bubbles through the liquid fuel 60 causing some of the liquid fuel 60 to vaporize forming a first air-fuel mixture 72. The first air-fuel mixture 72 then exits the outlet 18 in said first tank 12 and travels through the inlet 26 in the second tank 14 and percolates through the liquid fuel 62 in said second tank 14 to vaporize a portion of said liquid fuel 62 in the second tank 14 forming form a second air-fuel mixture 74. This second air-fuel mixture 74 then exits the outlet 20 in said second tank 14 and travels through the inlet 28 in the third tank 16 and percolates through the liquid fuel 64 in said third tank 16 to vaporize a portion of said liquid fuel 64 in the third tank 16 forming form a third air-fuel mixture 76. Finally, the third air-fuel mixture 76 exits the outlet 22 in the third tank 16 whereby the vaporized air-fuel mixture 76 is then drawn off for use in any application wherein such an air-fuel mixture 76 is normally utilized.

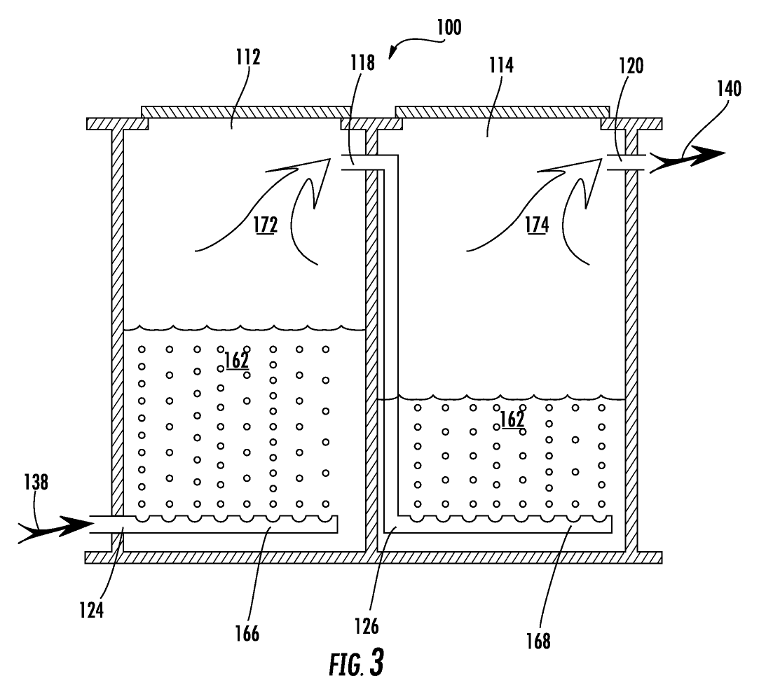

While the preferred embodiment described above depicts three tanks 12, 14, 16 wherein each of the tanks 12, 14, 16 are interconnected with one another to form a single body, it is also anticipated within the scope of the present invention that two tanks be employed or that any greater number of tanks be employed in a series arrangement. Further a series of separate tank compartments may also be utilized and still fall within the teachings of the present invention. For example, turning now to FIG. 3, an alternate embodiment system 100 is depicted wherein two interconnected tanks 112, 114 are depicted. In accordance with the teachings of the present invention, each of the tanks 112, 114 is constructed to include an inlet 124, 126 that connects to a manifold 166, 168 at the bottom thereof and an outlet 118, 120 near the top thereof. Each of the tanks 112, 114 is connected in series such that the airflow 138 is introduced into the first tank 112 through the first manifold 166. The output 118 on the first tank 112 is connected to the input 126 on the second tank 114, wherein the first airfuel mixture 172 produced in the first tank 112 is then injected into the second tank 114 via the manifold 168 provided therein. The important relationship to note is that the output on a tank must be above the level of liquid in the tank in order to prevent a transfer of liquid gasoline from tank to tank as the vapors are being concentrated. As can be seen, by utilizing multiple tanks or compartments in series, each step serves to produce a more highly concentrated gas vapor output. In other words, the second air-fuel mixture has a higher concentration of vaporized fuel than the first air-fuel mixture while a third air-fuel mixture has a higher concentration of vaporized fuel than the second.

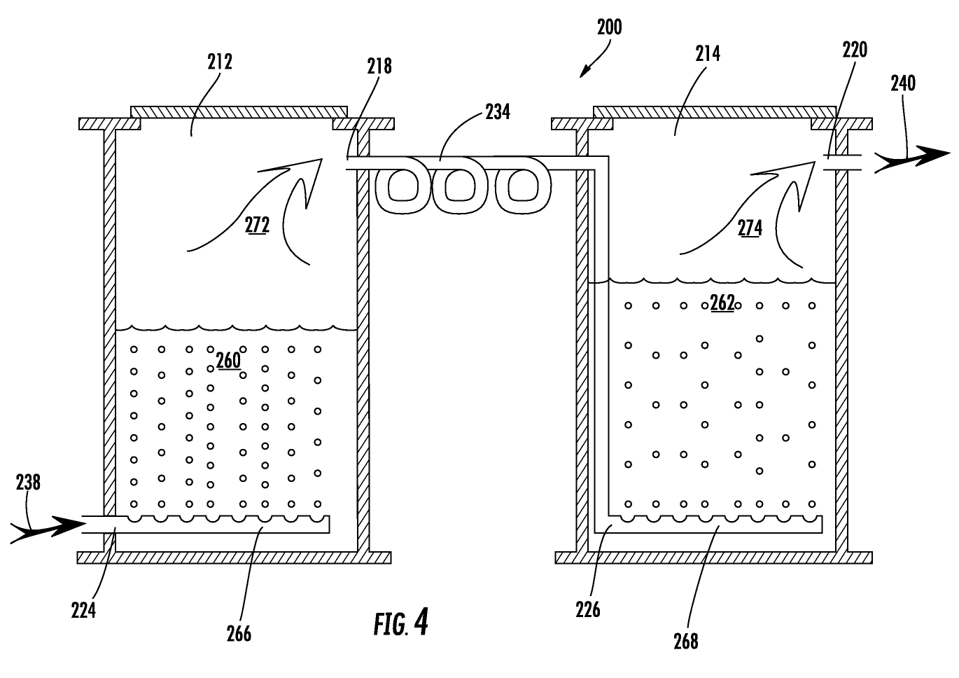

Turning now to FIG. 4 another alternate embodiment system 200 of the present invention is shown wherein the at least two tanks 212, 214 are shown as remote or separate from one another. This embodiment is the same as those described earlier in all aspects and operational features except that the two tanks 212, 214 are not physically attached to one another. Instead, a hose or pipe 234 is employed to make the fluid connection between the outlet 218 of the first tank 121 and the inlet 226 of the second tank 214. Airflow 238 is introduced to the input port 224 on the first tank 212 and is percolated via manifold 266 through the liquid fuel 260 contained therein to form a first air-fuel mixture 272. The first air fuel mixture 272 then is forced through outlet 218 to the manifold 268 in the second tank 214 where it percolates through the liquid fuel 262 to form a second air fuel mixture 274 that then exits the outlet 220 for use as a combustible fuel 240.

It is of note that the tanks used in the present invention may be fabricated metal tanks, molded polymer tanks or reinforced fiberglass tanks. The importance is not in the material employed of the construction of the tanks but in the arrangement of the manifolds and tank outputs as described above. Further the manifolds may be any suitable pipe or tubing material formed using a metal or a polymer. Further, it is possible that the manifolds may be formed integrally as a part of the bottom wall of the tanks themselves. The specific materials and configurations of the present invention are not meant to be critical or limiting and are only described to in order to illustrated the principals of the present invention.

Returning now to FIG. 3, also within the scope of the present invention a method of vaporizing a liquid fuel is disclosed wherein at least two tanks 112, 114 are provided that each include a top an bottom, an inlet 124, 126 proximate the bottom and an outlet 118, 120 proximate the top and further wherein the outlet 118 in a first one of the tanks 112 is in fluid communication with the inlet 126 in a second one of the tanks 114. Each of the two tanks 112, 114 are then partially filled with a liquid fuel 160, 162 to cover the inlets 124, 126 in each of the tanks 112, 114. A pressurized airflow 138 is then introduced to the inlet 124 in the first tank 112, wherein the pressurized airflow 138 enters the first tank 112, percolates through the liquid fuel 160 contained therein and vaporizes a portion of the liquid fuel 160 in the first tank 112 to form a first air-fuel mixture 172. This first air-fuel mixture 172 then exits the outlet 118 in the first tank 112 and is introduced into the inlet 126 in the second tank 114. The first air-fuel mixture 172 percolates through the liquid fuel 162 in the second tank 114 and vaporizes a portion of the liquid fuel 162 in the second tank 114 to form a second air-fuel mixture 174. Finally, the second air-fuel mixture 174 exits the outlet 120 in the second tank 114 in the form of a highly saturated air-fuel mixture 140 for use in a suitable combustion process.

In an operational example, three metallic tanks were connected in series with 5 gallons of gasoline in each tank. Compressed air was introduced to the inlet on the first tank at a pressure of 10 psi. The vaporized gasoline was drawn from the outlet on the third tank and directed to a torch assembly. The torch was burned wide open for 24 hours and consumed only 4 gallons of the original gasoline in vapor form.

It can therefore be seen that the present invention provides a novel method and system for the efficient vaporization of a liquid fuel in preparation for a combustion operation. The present invention further eliminates the residual liquid fuel droplets typically found in prior art systems to produce an air-fuel mixture that is highly saturated and serves to extract the highest potential energy from such a combustible fuel. For these reasons, the present invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A system for vaporizing a liquid fuel comprising:
a least two tanks, each of said at least two tanks having a top, a bottom, an inlet proximate said bottom and an outlet proximate said top, said outlet in a first of said tanks in fluid communication with said inlet in a second of said tanks; and
means for introducing a pressurized airflow to said inlet in said first tank
wherein said at least two tanks are at least partially filled with said liquid fuel, said liquid fuel covering said inlets.

2. The system of claim 1, wherein said pressurized airflow enters said first tank, percolates through said liquid fuel in said first tank and vaporizes a portion of said fuel in said first tank to form a first air-fuel mixture, said first air-fuel mixture exiting said outlet in said first tank and into said inlet in said second tank, percolates through said liquid fuel in said second tank and vaporizes a portion of said fuel in said second tank to form a second air-fuel mixture, said second air-fuel mixture exiting said outlet in said second tank.

3. The system of claim 2, wherein said second air-fuel mixture has a higher concentration of vaporized fuel that said first air-fuel mixture.

4. The system of claim 1, wherein said at least two tanks further comprises a plurality of tanks arranged in series the outlet of each tank in said series in fluid communication with the inlet of the next tank in said series.

5. The system of claim 1, further comprising:
a manifold positioned adjacent the bottom of each of said at least two tanks, said manifold in fluid communication with said inlet in said tank, said manifold including a plurality of holes therein to distribute said airflow evenly throughout said liquid fuel within said tank.

6. The system of claim 1, wherein each of said at least two tanks is attached to one another.

7. The system of claim 1, wherein each of said at least two tanks is remote from one another.

8. The system of claim 1, further comprising:
means for visually determining the level of liquid fuel within each of said at least two tanks; and
filler ports in each of said at least two tanks to allow additional liquid fuel to be added thereto.

9. A system for vaporizing a liquid fuel comprising:
a first tank having a top, a bottom, a first inlet proximate said bottom and a first outlet proximate said top;
a second tank having a top, a bottom, a second inlet proximate said bottom and a second outlet proximate said top, wherein said first outlet is in fluid communication with said second inlet; and
means for introducing a pressurized airflow to said first inlet,
wherein said first and second tanks are at least partially filled with said liquid fuel, said liquid fuel covering said first and second inlets.

10. The system of claim 9, wherein said pressurized airflow enters said first tank, percolates through said liquid fuel in said first tank and vaporizes a portion of said fuel in said first tank to form a first air-fuel mixture, said first air-fuel mixture exiting said first outlet and into said second inlet in said second tank, percolates through said liquid fuel in said second tank and vaporizes a portion of said fuel in said second tank to form a second air-fuel mixture, said second air-fuel mixture exiting said second outlet.

11. The system of claim 10, wherein said second air-fuel mixture has a higher concentration of vaporized fuel that said first air-fuel mixture.

12. The system of claim 9, further comprising:
a third tank having a top, a bottom, a third inlet proximate said bottom and a third outlet proximate said top, wherein said second outlet is in fluid communication with said third inlet.

13. The system of claim 12, wherein said pressurized airflow enters said first tank, percolates through said liquid fuel in said first tank and vaporizes a portion of said fuel in said first tank to form a first air-fuel mixture, said first air-fuel mixture exiting said first outlet and into said second inlet in said second tank, percolates through said liquid fuel in said second tank and vaporizes a portion of said fuel in said second tank to form a second air-fuel mixture, said second air-fuel mixture exiting said second outlet and into said third inlet in said third tank, percolates through said liquid fuel in said third tank and vaporizes a portion of said fuel in said third tank to form a third air-fuel mixture, said third air-fuel mixture exiting said second outlet.

14. The system of claim 13, wherein said third air-fuel mixture has a higher concentration of vaporized fuel that said second air-fuel mixture and said second air-fuel mixture has a higher concentration of vaporized fuel that said first air-fuel mixture.

15. A method of vaporizing a liquid fuel comprising:
providing at least two tanks, each of said at least two tanks having a top, a bottom, an inlet proximate said bottom and an outlet proximate said top, said outlet in a first of said tanks in fluid communication with said inlet in a second of said tanks;
partially filling said at least two tanks with said liquid fuel, said liquid fuel covering said inlets;
introducing a pressurized airflow to said inlet in said first tank, wherein said pressurized airflow enters said first tank, percolates through said liquid fuel in said first tank and vaporizes a portion of said fuel in said first tank to form a first air-fuel mixture, said first air-fuel mixture exiting said outlet in said first tank; and
introducing said first air-fuel mixture into said inlet in said second tank, wherein said first air-fuel mixture percolates through said liquid fuel in said second tank and vaporizes a portion of said fuel in said second tank to form a second air-fuel mixture, said second air-fuel mixture exiting said outlet in said second tank.

16. The method of claim 15, wherein said second air-fuel mixture has a higher concentration of vaporized fuel that said first air-fuel mixture.

17. The method claim 15, wherein said at least two tanks further comprises a plurality of tanks arranged in series, the outlet of each tank in said series in fluid communication with the inlet of the next tank in said series.

18. The method of claim 15, further comprising:
a manifold positioned adjacent the bottom of each of said at least two tanks, said manifold in fluid communication with said inlet in said tank, said manifold including a plurality of holes therein to distribute said airflow evenly throughout said liquid fuel within said tank.
